(19) United States
(12) Patent Application Publication
(10) Pub. No.: US 2019/0360749 A1
(43) Pub. Date: Nov. 28, 2019

(54) ROLL-TRANSPORT DEVICE

(71) Applicant: HONDA MOTOR CO., LTD., Tokyo (JP)

(72) Inventors: Hiroshi Sakai, Tochigi (JP); Kenichi Yokoo, Tochigi (JP)

(21) Appl. No.: 16/418,238

(22) Filed: May 21, 2019

(30) Foreign Application Priority Data
May 23, 2018 (JP) 2018-098527

(51) Int. Cl. F27B 9/04; C21D 1/767; C21D 9/56; C21D 1/52; C21D 9/00; F27B 9/24; F27D 7/02

(52) U.S. Cl. CPC F27B 9/047; C21D 1/767; C21D 9/563; C21D 1/52; F27D 2007/023; C21D 9/0056; F27B 9/2407; F27D 7/02; C21D 9/0012

(57) ABSTRACT

A roll-transport device including: a roll that comes into contact with the base material; a support shaft that rotatably supports the roll; and a bearing that is disposed on an outer peripheral surface of the support shaft and has an end surface on one side in an axial direction, which faces an inside of a furnace, and an end surface on the other side in the axial direction, which is positioned on a side of an inner portion (space surrounded by the roll). A purge gas is caused to circulate from the end surface on the other side toward the end surface on the one side of the bearing, and the purge gas is discharged into the furnace from the end surface on the one side of the bearing.

This application is based on and claims the benefit of priority from Japanese Patent Application No. 2018-098527, filed on 23 May 2018, the content of which is incorporated herein by reference.

### BACKGROUND OF THE INVENTION

### Field of the Invention

The present invention relates to a roll-transport device that transports a sheet-shaped transport-target object in a furnace.

### Related Art

In the related art, there is known a technology for transporting a sheet-shaped transport-target object by using a roll in a furnace in which a firing step is performed. For example, as this type of technology, a technology is described in Patent Document 1. Patent Document 1 describes that an inert gas supply pipe, through which an inert gas is injected into a space between a sealing member and a bearing, is connected to an annealing furnace roll bearing configured to have a sealed bearing box, which houses the bearing of a roll shaft of a roll in a continuous annealing furnace, and the sealing member, which seals a space between the bearing box and the roll shaft, and the inert gas is injected into the space between the sealing member and the bearing at furnace pressure or static pressure equal to or higher than the furnace pressure.

Patent Document 1: Japanese Unexamined Utility Model Application, Publication No. H6-47349

### SUMMARY OF THE INVENTION

Incidentally, when a lubricant turns into foreign matter by a chemical reaction and is accumulated on a rolling contact surface or the like of a bearing, the following is found. Resistance against rotation of a roll increases, and thus rotation malfunction occurs. In this respect, in the Patent Document 1, the inert gas is injected, and thereby it is possible to prevent the lubricant from turning into defective matter due to condensation. However, the lubricant or a substance, which is other than the lubricant and is formed depending on a material that is transported in the furnace, is accumulated as foreign matter on the rolling contact surface of the bearing, and thereby it hinders prolongation of service life of the bearing.

An object of the invention is to provide a configuration in which it is possible to effectively prevent rotation malfunction of a roll from occurring due to attachment of foreign matter on a bearing, in a roll-transport device that is used in a furnace.

The invention relates to a roll-transport device (for example, a free roll device 10 to be described below) that transports a sheet-shaped transport-target object (for example, a base material 101 to be described below) and is provided in a furnace (for example, a furnace 5 to be described below), in which a firing process is performed, the roll-transport device including: a roll (for example, a roll 50 to be described below) that comes into contact with the transport-target object; a support shaft (for example, a support shaft 52 to be described below) that rotatably supports the roll; and a bearing (for example, a bearing 60 to be described below) that is disposed on an outer peripheral surface of the support shaft and has a surface on one side (for example, an end surface 610 on one side in an axial direction, which will be described below), which faces an inside of the furnace, and a surface on the other side (for example, an end surface 620 on the other side in the axial direction, which will be described below), which is positioned on a side of a space (for example, an inner portion 500 to be described below) surrounded by the roll. A purge gas is caused to circulate from the surface on the other side toward the surface on the one side of the bearing, and the purge gas is discharged into the furnace from the surface on the one side of the bearing.

Consequently, it is possible to effectively limit attachment of foreign matter in the furnace to the bearing (for example, a rolling contact surface), and thus it is possible to prolong service life of the bearing.

It is preferable that the support shaft has an inner portion that is provided with a flow channel (for example, a purge gas flow channel 520 and a purge gas discharge port 521 to be described below) which is extended along an axial direction and guides the purge gas from an outer side toward an inner side of the roll, at least one of the support shaft and the roll is provided with a partition wall (for example, a part of the support shaft 52 and a collar 55 to be described below) having an opposite surface (for example, an end surface 57 of the collar 55 and a stepped surface 528 to be described below) that is opposite to the bearing in the axial direction of the roll, and the purge gas supplied to the inner side of the roll through the flow channel is guided to flow toward the side of the bearing by the opposite surface.

Consequently, since a route through which the purge gas circulates is formed in the support shaft that rotatably supports the roll and does not rotate, it is possible to realize a configuration in which the purge gas is introduced to the bearing without a complication of layout.

It is preferable that the opposite surface is positioned closer to the inner side of the roll than a discharge port (for example, the purge gas discharge port 521 to be described below) through which the purge gas is discharged in the flow channel.

Consequently, it is possible to cause the purge gas discharged from the flow channel to more efficiently return to the side of the bearing.

It is preferable that the roll-transport device further includes a narrowing member (for example, the collar 55 to be described below) that is provided on an outer periphery of the support shaft and narrows a gap between the support shaft and the roll.

Consequently, it is possible to limit a flow of the purge gas into the inner side of the roll and obtain an efficient flow of the purge gas to the side of the bearing, in a simple configuration in which the narrowing member is disposed on the support shaft.

It is preferable that the purge gas is made of a nitrogen gas.

Consequently, it is possible to scavenge oxygen or water vapor from the bearing and a periphery of the bearing, and it is possible to effectively limit oxidation of a lubricant or the like of the bearing. Hence, it is possible to more effectively prevent rotation malfunction of the roll from occurring.

According to the invention, it is possible to effectively prevent rotation malfunction of a roll from occurring due to attachment of foreign matter on a bearing, in a roll-transport device that is used in a furnace.

### BRIEF DESCRIPTION OF THE DRAWINGS

FIG. 1 is a diagram schematically illustrating a configuration of a coating/firing apparatus using a free roll device according to an embodiment of the invention.

FIG. 2 is a sectional view illustrating a bearing and a periphery of the bearing of the free roll device of the embodiment.

FIG. 3 is an enlarged sectional view illustrating the bearing and the periphery of the bearing of the free roll device of the embodiment.

### DETAILED DESCRIPTION OF THE INVENTION

Hereinafter, as a preferred embodiment of the invention, a free roll device that is used in a coating/firing step of a manufacturing process of a fuel cell (FC) stack will be described.

First, an overall configuration of the manufacturing process of the fuel cell (FC) stack will be described. A manufacturing step of a membrane-electrode assembly (MEA) 100 that is manufactured by using the free roll device according to an embodiment of the invention largely includes a coating/firing step, a laminating step, a resin frame bonding step, a laminating and assembling step, and a completion inspecting step.

In the coating/firing step, rolls of separate carbon paper (CP) are coated with respective pastes that play roles of a cathode (Ca) and an anode (An), and the pastes are heated and fired. Further, Ca is formed through transfer printing on an electrolyte membrane (PEM) and forms an electrode of a fuel cell. In the laminating step, three layers thereof are cut out (trimmed) to have a size of about 300 mm×100 mm and, then, are overlapped on each other to be integrated with each other, for example. The MEA is completed through such integration. After the laminating step, the resin frame bonding step of bonding the MEA and a resin frame by an adhesive and resin impregnation is performed, then, the laminating and assembling step and the completion inspecting step are performed, and the FC stack is completed.

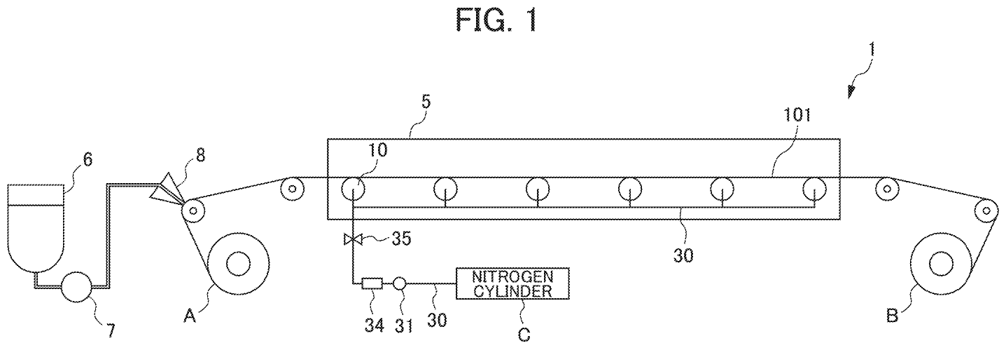

Next, a device that is used in the coating/firing step will be described. FIG. 1 is a diagram schematically illustrating a configuration of a coating/firing apparatus 1 using a free roll device 10 according to the embodiment.

In a coating/firing process, after a paste stored in a paste storage unit 6 is supplied to a coating unit 8 by a pump 7, and a base material (transport-target object) 101 is coated with the paste by the coating unit 8, drying and firing are performed. A plurality of free roll devices 10 that transport the base material 101 are disposed inside a furnace 5 of the coating/firing apparatus 1. The base material 101 unwound from a roll A for unwinding is transported by the free roll devices 10 from an inside to an outside of the coating/firing apparatus 1 and is wound around a roll B for winding.

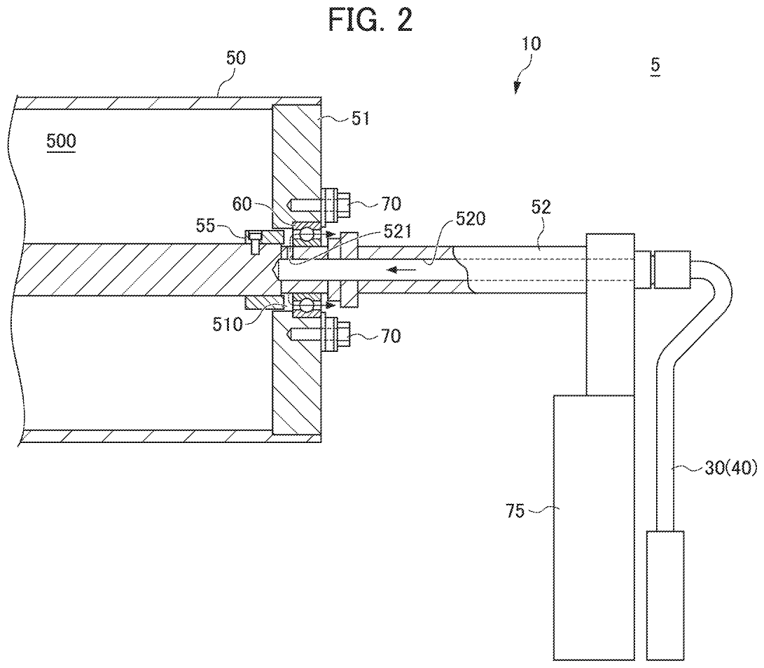

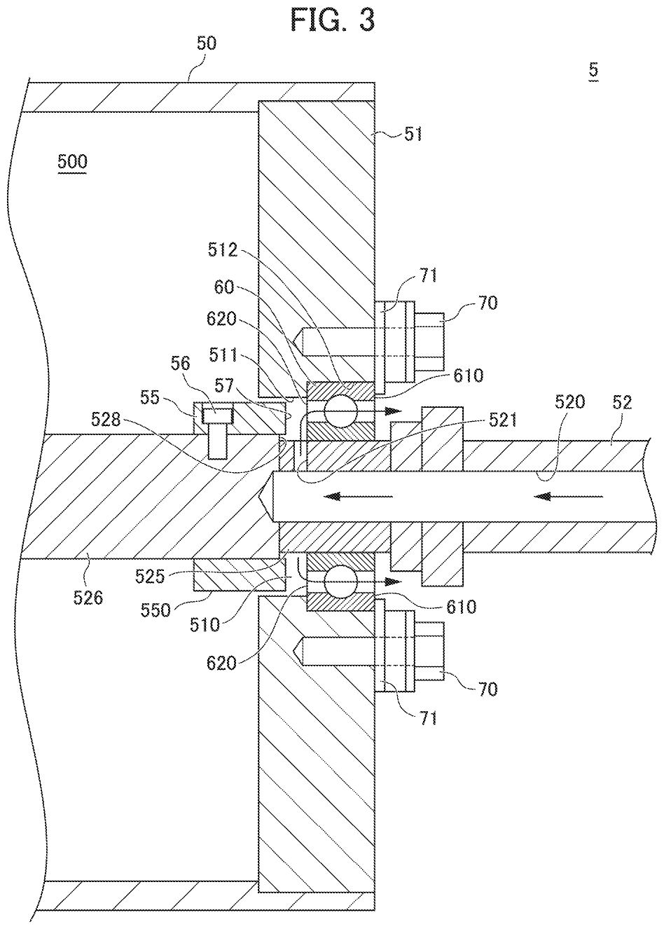

In addition, the coating/firing apparatus 1 includes a purge gas supply route (positive pressure piping route) through which a purge gas that cleans a bearing 60 (refer to FIGS. 2 and 3) of the free roll device 10 is supplied from the outside of the furnace 5. In the embodiment, the purge gas is supplied by a purge gas pipe 30 through which the purge gas is supplied to the free roll device 10.

The purge gas pipe 30 is connected to a nitrogen cylinder C, and a regulator 31, a flowmeter 34, and a valve 35 are disposed on the purge gas pipe from upstream toward downstream. Hence, a flow rate (pressure) of a nitrogen gas that is the purge gas flowing in the purge gas pipe 30 is adjusted. The purge gas pipe 30 diverges to cause the purge gas to be supplied to each of the plurality of free roll devices 10.

A structure of supplying the purge gas to the bearing 60 of the free roll device 10 will be described. FIG. 2 is a sectional view illustrating the bearing and a periphery of the bearing of the free roll device 10 of the embodiment, and FIG. 3 is an enlarged sectional view illustrating the periphery of the bearing in FIG. 2. Incidentally, FIGS. 2 and 3 illustrate only one side of the free roll device 10 in an axial direction. The free roll device 10 has a configuration on the other side in the axial direction, which is common to or the same as the configuration on the one side.

The free roll device 10 includes a roll 50 on which the base material 101 (not illustrated in FIGS. 2 and 3) is placed as a transport-target object, a support shaft 52 that rotatably supports the roll 50, the bearing 60 that is fixed to the support shaft 52, and a collar 55 that is fixed to the support shaft 52.

The roll 50 is a cylindrical member having a hollow inner portion 500. A circular through-hole 510 is formed at the center of an end surface plate 51 on one side in the axial direction (or the other side in the axial direction) of the roll 50. As illustrated in FIG. 3, the through-hole 510 has a step shape of which an inner diameter of an inner peripheral surface 511 on a side of the inner portion 500 of the roll 50 in the axial direction is smaller than an inner diameter of an inner peripheral surface 512 on an inner side of the furnace 5 in the axial direction.

The support shaft 52 is held by a roll frame 75 as a support base. The bearing 60 is fixed to an outer peripheral surface of the support shaft 52. The support shaft 52 of the embodiment has a step shape including a small-diameter portion 525 having a relatively small diameter in the through-hole 510 on the inner side of the furnace 5 and a large-diameter portion 526 having a relatively large diameter.

The bearing 60 is fixed to the small-diameter portion 525 of the support shaft 52 at a position at which at least a part of the bearing is opposite to the inner peripheral surface 512 of the through-hole 510 on the inner side of the furnace 5. The bearing 60 has an end surface 610 on one side in the axial direction, which faces the inside of the furnace 5, and an end surface 620 on the other side in the axial direction is positioned on the side of the inner portion 500 of the roll 50.

In addition, an annular fixing member 71 is fixed to the end surface plate 51 with a plurality of fastening members 70, and thus a positional relationship is obtained, in which a part of the fixing member 71 and a part of an end surface of the bearing 60 on the inner side of the furnace 5 are opposite to each other in the axial direction.

A solid lubricant (for example, MoS₂-based solid lubricant) is used in the bearing 60 of the embodiment.

The collar 55 is a cylindrical member and is fixed to an outer peripheral surface of the large-diameter portion 526 of the support shaft 52 with a fastening member 56. A length of the collar 55 in the axial direction is set such that an end portion on one side of the collar is positioned in the through-hole 510, and an end portion on the other side thereof is positioned on the side of the inner portion 500 of the roll 50. In addition, the end portion of the collar 55 which is positioned in the through-hole 510 projects more toward the inner side of the furnace 5 than an end surface (stepped surface 528) of the large-diameter portion 526 and is opposite to a part of an outer peripheral surface of the small-diameter portion 525 in a radial direction.

An outer diameter of an outer peripheral surface 550 of the collar 55 is set to be slightly smaller than the inner diameter of the inner peripheral surface 511 of the through-hole 510 on the side of the inner portion 500 of the roll 50. Consequently, a very small gap is formed between the outer peripheral surface 550 of the collar 55 and the inner peripheral surface 511 of the through-hole 510.

Next, a flow of the purge gas that is a nitrogen gas which is supplied to the free roll device 10 will be described. A purge gas flow channel 520 that is extended along the axial direction and a purge gas discharge port 521 that is extended from the purge gas flow channel 520 to the outer peripheral surface of the small-diameter portion 525 of the support shaft 52 on an outer side in the radial direction are provided as a purge gas supply route in an inner portion of the support shaft 52 of the embodiment.

The purge gas flow channel 520 is extended from the end surface of the support shaft 52 to the vicinity of a surface of the end surface plate 51 on the inner side in the axial direction without interruption in the axial direction. The purge gas pipe 30 as a positive pressure pipe is connected to an end portion on one side of the purge gas flow channel 520, and the purge gas is supplied to the purge gas flow channel 520 through the purge gas pipe 30.

One or a plurality of purge gas discharge ports 521 are formed at a position opposite to the inner peripheral surface 511 of the through-hole 510 in the vicinity of a terminal portion of the purge gas flow channel 520. The purge gas discharge port 521 of the embodiment is formed at a position displaced from the bearing 60 in the axial direction. The purge gas supplied to the purge gas flow channel 520 flows out into the through-hole 510 through the purge gas discharge port 521.

The purge gas flowing out into the through-hole 510 reaches the bearing 60 from the outer side of the support shaft 52 (small-diameter portion 525). The through-hole 510 is continuous in a peripheral direction, the purge gas is supplied not only to a periphery of the purge gas discharge port 521 but also the entire periphery of the bearing 60.

In the embodiment, the support shaft is provided with the stepped surface 528 that is formed by a step between the small-diameter portion 525 and the large-diameter portion 526, and the stepped surface 528 faces the bearing 60 in the axial direction. In addition to this, an end surface 57 of the collar 55 also faces the bearing 60 in the axial direction. The stepped surface 528 of the support shaft 52 and the end surface 57 of the collar 55 are both positioned closer to the side of the inner portion 500 of the roll 50 than the purge gas discharge port 521. A flow of the purge gas discharged from the purge gas discharge port 521 to the side of the inner portion 500 of the roll 50 is hindered by the stepped surface 528 of the support shaft 52 and the end surface 57 of the collar 55, and the purge gas is guided to the side (direction of an arrow) of the bearing 60. The purge gas guided to the side of the bearing 60 escapes from the gap of the bearing 60 and is discharged into the furnace.

As described above, a nitrogen gas is supplied as the purge gas to the periphery of the bearing 60 of the free roll device 10. In addition, the purge gas is similarly supplied to the bearing 60 that is disposed on the other side in the axial direction. As described above, the solid lubricant containing MoS₂ is used in the bearing 60, and thus an oxidation reaction is likely to occur in a temperature range equal to or higher than a predetermined temperature under an oxygen or water vapor atmosphere. When the solid lubricant with which the oxidation reaction is likely to occur under the oxygen or water vapor atmosphere is used, it is preferable that the nitrogen gas that is a fluid free from oxygen and water vapor is supplied as a purge gas. Incidentally, instead of the nitrogen gas, it is possible to use low-temperature dry air as a purge gas and obtain a state in which oxidation is unlikely to occur on the periphery of the bearing 60.

In addition, it is preferable that a flow rate of the purge gas that escapes from the gap of the bearing 60 and is discharged into the furnace is set to the extent that the purge gas does not influence a temperature in the furnace 5.

According to the embodiment, the following effects are achieved. The free roll device 10 that transports the sheet-shaped base material 101 is provided in an inside of the furnace 5, in which the firing process is performed, and includes the roll 50 that comes into contact with the base material 101; the support shaft 52 that rotatably supports the roll 50; and the bearing 60 that is disposed on the outer peripheral surface of the support shaft 52 and has the end surface 610 on the one side in the axial direction, which faces the inside of the furnace 5, and the end surface 620 on the other side in the axial direction, which is positioned on the side of the inner portion (space surrounded by the roll 50) 500. The purge gas is caused to circulate from the end surface 620 on the other side toward the end surface 610 on the one side of the bearing 60, and the purge gas is discharged into the furnace 5 from the end surface on the one side of the bearing. Consequently, it is possible to effectively limit accumulation of foreign matter in the furnace to a rolling contact surface of the bearing 60, and thus it is possible to prolong service life of the bearing 60.

In addition, the support shaft 52 of the embodiment has an inner portion that is provided with the purge gas flow channel 520 and the purge gas discharge port 521 which are extended along the axial direction and guide the purge gas from the outer side toward the inner side of the roll. The support shaft 52 includes a part of the support shaft 52 and the collar 55 which function as a partition wall having the opposite surface (the end surface 57 of the collar 55 and the stepped surface 528) that is opposite to the bearing 60 in the axial direction of the roll 50. Thus, the purge gas supplied to the inner side of the roll 50 through the purge gas flow channel 520 and the purge gas discharge port 521 is guided to flow toward the side of the bearing by the end surface 57 of the collar 55 and the stepped surface 528. Consequently, since the route through which the purge gas circulates is formed in the support shaft 52 that rotatably supports the roll 50 and does not rotate, it is possible to realize the configuration in which the purge gas is introduced to the bearing 60 without a complication of layout (complex design). The end surface 57 of the collar 55 and the stepped surface 528 are positioned closer to the inner portion 500 of the roll 50 than the purge gas discharge port 521. Consequently, it is possible to cause the purge gas discharged from the purge gas discharge port 521 to more efficiently return to the side of the bearing 60.

In addition, the free roll device 10 of the embodiment includes the collar 55 as a narrowing member that is provided on the outer periphery of the support shaft and narrows the gap between the support shaft 52 and the roll 50. Consequently, it is possible to limit the flow of the purge gas into the inner side of the roll 50 and obtain an efficient flow of the purge gas to the side of the bearing 60, in a simple configuration in which the collar 55 is disposed on the support shaft 52.

In addition, the purge gas is made of the nitrogen gas. Consequently, it is possible to scavenge oxygen or water vapor from the bearing 60 and the periphery thereof, and it is possible to effectively limit oxidation of the lubricant or the like of the bearing 60. Hence, it is possible to more effectively prevent rotation malfunction of the roll 50 from occurring.

As described above, the preferred embodiment of the invention is described; however the invention is not limited to the embodiment described above and can be appropriately modified.

In the embodiment, the configuration is described as an example in which the nitrogen gas is supplied as a purge gas to the free roll device 10; however, the embodiment is not limited to the configuration. Instead of the nitrogen gas, the low-temperature dry air may be used as the purge gas depending on a circumstance of a device configuration.

In the embodiment, the collar 55 is configured as a separate member so as to be fixed to the support shaft 52; however, the embodiment is not limited to the configuration. The collar 55 may not formed into the annular shape but may be formed as a C-shaped member. In addition, the support shaft 52 may be molded to integrally include the shape corresponding to the collar 55, or the shape corresponding to the collar 55 may be formed on the side of the end surface plate 51 (roll 50). In addition, the coating/firing apparatus 1 using the free roll device 10 can be appropriately modified according to circumstances.

What is claimed is:

1. A roll-transport device that transports a sheet-shaped transport-target object and is provided in a furnace, in which a firing process is performed, the roll-transport device comprising:
a roll that comes into contact with the transport-target object;
a support shaft that rotatably supports the roll; and
a bearing that is disposed on an outer peripheral surface of the support shaft and has a surface on one side, which faces an inside of the furnace, and a surface on the other side, which is positioned on a side of a space surrounded by the roll,
wherein a purge gas is caused to circulate from the surface on the other side toward the surface on the one side of the bearing, and the purge gas is discharged into the furnace from the surface on the one side of the bearing.

2. The roll-transport device according to claim 1, wherein the support shaft has an inner portion that is provided with a flow channel which is extended along an axial direction and guides the purge gas from an outer side toward an inner side of the roll,
wherein at least one of the support shaft and the roll is provided with a partition wall having an opposite surface that is opposite to the bearing in the axial direction of the roll, and
wherein the purge gas supplied to the inner side of the roll through the flow channel is guided to the side of the bearing by the opposite surface.

3. The roll-transport device according to claim 2, wherein the opposite surface is positioned closer to the inner side of the roll than a discharge port through which the purge gas is discharged in the flow channel.

4. The roll-transport device according to claim 2, further comprising:
a narrowing member that is provided on an outer periphery of the support shaft and narrows a gap between the support shaft and the roll.

5. The roll-transport device according to claim 3, further comprising:
a narrowing member that is provided on an outer periphery of the support shaft and narrows a gap between the support shaft and the roll.

6. The roll-transport device according to claims 1, wherein the purge gas is made of a nitrogen gas.

7. The roll-transport device according to claims 2, wherein the purge gas is made of a nitrogen gas.

8. The roll-transport device according to claims 3, wherein the purge gas is made of a nitrogen gas.

9. The roll-transport device according to claims 4, wherein the purge gas is made of a nitrogen gas.

10. The roll-transport device according to claims 5, wherein the purge gas is made of a nitrogen gas.
